(19) United States
(12) Patent Application Publication
(10) Pub. No.: US 2004/0156963 A1
(43) Pub. Date: Aug. 12, 2004

(54) Amoroso wooden perforated peels

(76) Inventor: Nicolo Amoroso, Cave Creek, AZ (US)

Correspondence Address: Nicolo Amoroso, 27632 N. 45th Way, Cave Creek, AZ, 85331, US

(21) Appl. No.: 10/313,579

(22) Filed: Feb. 12, 2003

(51) Int. Cl. A23P 1/00

(52) U.S. Cl. 426/482

(57) ABSTRACT

This invention relates to an improvement on the conventional wooden pizza peel. This peel is equipped with holes, therefore making the conventional pizza peel perforated. When the pizza dough is stretched and placed on the perforated wooden peel, taping the wooden perforated peel vertically on a hard surface pushes air through the holes of the peel. Air is trapped between the wooden perforated peel and the pizza dough creating easy movement, allowing the pizza dough to slide into the oven more easily.

### BACKGROUND OF INVENTION

### FIELD OF INVENTION

The invention relates to a culinary device, and particularly an improved pizza peel for the handling of pizza dough.

The invention further relates to an improved pizza peel, which provides easy pizza movement between the wooden perforated pizza peel and the pizza dough to be inserted into the oven. More practically, the invention is directed toward the food handler. The food handler puts pizza dough on the wooden perforated peel adds all ingredients, then taps the wooden perforated peel vertically on a hard surface, trapping air between the wooden perforated peel and the pizza dough. This allows easy movement when inserting pizza into the oven.

### SUMMARY OF INVENTION

The improved wooden pizza peel allows for quick insertion of pizza into the oven without sticking to the board, making it easier and more accurate for the food handler to work with.

The improved wooden perforated pizza peel is also for sanitary purposes. Traditionally, the food handler would blow air via the mouth to trap air between the peel and the pizza dough witch is unsanitary for the consumer.

The improved wooden perforated pizza peel reduces the amount of flour needed to bake pizza. By minimizing the use of four, there is a decreased risk for burning the bottom of the pizza dough.

### DESCRIPTION OF THE SEVERAL VIEWS OF THE DRAWINGS

FIG. 1 Shows the overall dimensions of the top view.

FIG. 2 Shows the overall dimensions of the side view.

FIG. 3 Shows a three dimensional view.

### DESCRIPTION OF THE PREFERRED EMBODIMENT(S) OF THE INVENTION

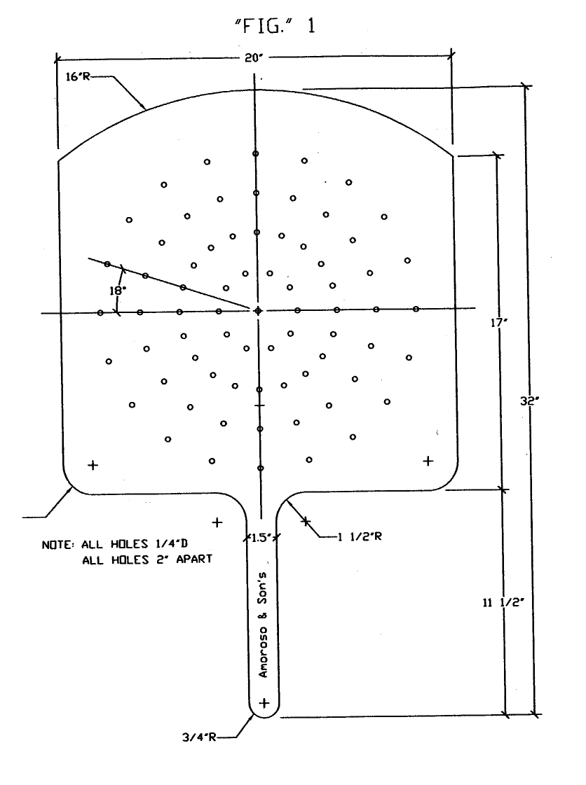

FIG. 1 This dimension is 20″×20″ with a 11½″ handle. The holes are 360 degrees on a flat board, with 18 degree increments, 2″ spacing between holes. All holes are ¼″.

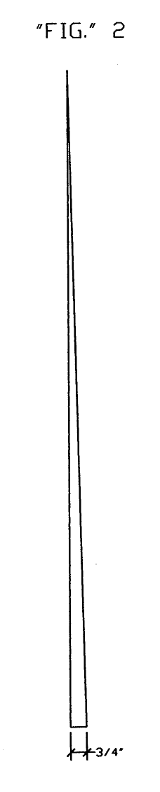

FIG. 2 This shows the thickness which is ¾″ at the handle to zero at the end.

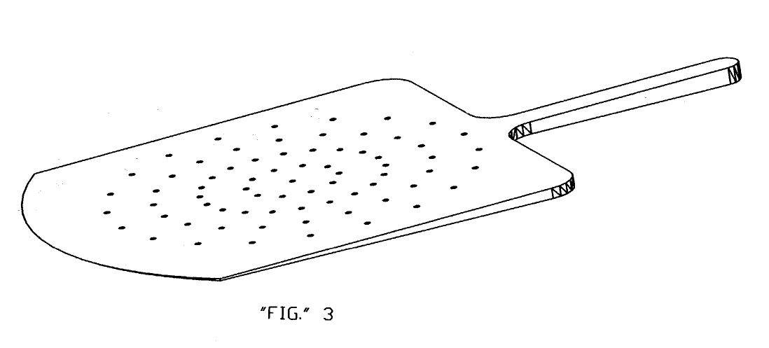

FIG. 3 Shows a three dimensional show piece.

I Nicolo Amoroso claim my invention as is the following:

1. A wooden pizza peel for the handling of pizza dough. A wooden flat board with a non removable handle with holes, making the board perforated, used for inserting pizza into the oven without dough sticking to the board.

2. The apparatus of claim 1, the wooden perforated peel can be in dimensions of 6″×6″ peel and vary in sizes to 48″×48″ peel with various size handles.

3. The apparatus of claim 1, the holes on the wooden perforated peel can vary in sizes from 1/16″ through 3″ and plus.

4. The apparatus of claim 1, the wooden perforated peel can also be made in any heat resistance plastic.
